(19) United States
(12) Patent Application Publication
(10) Pub. No.: US 2014/0219690 A1
(43) Pub. Date: Aug. 7, 2014

(54) DEVELOPER CARTRIDGE

(71) Applicants: Zhengguang Li, Zhuhai (CN); Wenyi Fan, Zhuhai (CN)

(72) Inventors: Zhengguang Li, Zhuhai (CN); Wenyi Fan, Zhuhai (CN)

(73) Assignee: "PRINT-RITE"." UNICORN" IMAGE PRODUCTS CO., LTD. OF ZHUHAI, Zhuhai (CN)

(21) Appl. No.: 14/343,976

(22) PCT Filed: Sep. 7, 2012
(86) PCT No.: PCT/CN2012/081101

§ 371 Date: Mar. 10, 2014

(30) Foreign Application Priority Data
Sep. 23, 2011 (CN) 201110285008.3

(51) Int. Cl. G03G 15/08

(52) U.S. Cl. CPC G03G 15/0865; G03G 15/0889
USPC 399/279

(57) ABSTRACT

A developer cartridge comprises a cartridge box, a stirring member, a developing roller, a gear set which receives driving force and drives the stirring member and the developing roller; a rotation member which is installed on the exterior wall of the cartridge box and is provided with a clutch gear and a coaxial cam wherein the clutch gear has a small-diameter portion which is clearance-fitted with one gear top of the gear set and a large-diameter portion which is interference-fitted with the gear top and wherein the large-diameter portion is provided with an elastic friction layer along the circumference and the cam is in a staggered phase with the clutch gear; a contact member which is installed on the exterior wall of the cartridge box and has a contact end and a trigger end; and an elastic member which is installed between the cartridge box and the contact member.

### FIELD OF THE INVENTION

The invention relates to a developer cartridge which is used for electrophotography imaging devices. This patent application claims priority from Chinese Invention Patent Application No. 201110285008.3, filed on Sep. 23, 2011, the disclosure of which is incorporated herein by reference.

### BACKGROUND OF THE INVENTION

Electrophotography imaging devices commonly use detachable developer cartridges for developing on electrostatic latent image on the photosensitive member and print the image onto a paper or other medium. Methods for detecting whether a developer cartridge is new are known. For instance, Chinese Patent. CN100470394C discloses a developer cartridge. The developer cartridge comprises a cartridge box which comprises a toner compartment and a toner outlet. The toner compartment comprises a stirring frame. A developing roller is installed on the toner outlet. A gear set which drives the stirring frame and the developing roller is installed on the exterior wall of the cartridge box. A detection gear having a bare portion may be engaged with the driving gear of the stirring frame and the developing roller; and the detection gear is equipped with a contact projection which may trigger the contact member of the electrophotography imaging device. When a new developer cartridge is mounted to the electrophotography imaging device, the driving gear is driven to rotate and it then drives the engaged detection gear to rotate. The contact projection of the detection gear rotates and triggers the contact member of the electrophotography imaging device. The electrophotography imaging device detects a new developer cartridge. When the detection gear rotates to the bare portion and faces the driving gear, it is disengaged from the driving gear, and the detection gear no longer rotates with the driving gear; and the contact projection of the detection gear moves to a position in which it is not in contact with the electrophotography imaging device. When a used developer cartridge is mounted to the electrophotography imaging device, the detection gear will not rotate with the driving gear, the contact projection of the detection gear will not trigger the contact member of the electrophotography imaging device, and thus the electrophotography imaging device can indicate that the developer cartridge is not new.

Chinese Patent CN1828446B discloses a developer cartridge which is essentially the same as the developer cartridge discussed in the above patent except that the electrophotography imaging device has several members to be contacted. If the developer cartridge is new, the contact projections of the detection gear will trigger the contact, members during the rotation of the detection gear and the number of the printings the developer cartridge can print is detected. If there are two contact projections, the developer cartridge can print up to 8000 pages; if there is one contact projection, the developer cartridge can print up to 4000 pages. When a used developer cartridge is mounted to the electrophotography imaging device, the bare portion of the detection gear will face the driving gear, the detection gear will not rotate with the driving gear, and the contact projection of the detection gear will not trigger the contact member of the electrophotography imaging device.

### TECHNICAL PROBLEMS

The developer cartridges disclosed in the above patents use the detection gears which have bare portions to detect, whether the developer cartridge is new. Such detection gears are complex and difficult as well as costly to make. Therefore the developer cartridges of these gear structures are also costly to make. The detection locations of the contact members of the electrophotography imaging devices and the contact projections of the detection gears are restricted to within the rotation radius of the contact projections.

Therefore, new developer cartridges are needed. Ideally, the developer cartridges would be easy to make. Ideally, the developer cartridges would not have restricted detection locations.

### TECHNICAL SOLUTIONS

The objective of the invention is to provide a simple, low cost developer cartridge which has unrestricted detection location.

To achieve the above objective, the invention provides the following technical scheme.

The developer cartridge comprises a cartridge box which comprises a toner compartment and a toner outlet; a stirring member which is rotationally supported inside the toner compartment; a developing roller which is rotationally supported on the toner outlet; a gear set installed on the exterior wall of the cartridge box which receives driving force and drives the stirring member and the developing roller; a rotation member which is rotationally installed on the exterior wall of the cartridge box and is provided with a clutch gear and a coaxial cam, wherein the clutch gear comprises a small-diameter portion which is clearance-fitted with one gear top of the gear set and a large-diameter portion which is interference-fitted with the gear top, and wherein the large-diameter portion is provided with an elastic friction layer along the circumference and the cam is in a staggered phase with the clutch gear; a contact member which is rotationally installed on the exterior wall of the cartridge box and has a contact end for contacting with the cam and a trigger end; and an elastic member which is installed between the cartridge box and the contact member and forces the contact end to contact with the cam.

Preferably, the contact member is rotationally installed on the exterior wall of the cartridge box and the elastic member is a torsion spring. The rotation of the rotation member drives the contact member to rotate. The torsion spring causes the contact end to remain in contact with the cam of the rotation member; during the rotation, the trigger end triggers the contact member of the electrophotography imaging device.

Preferably, the cam is provided with two or more projections along the circumference. The use of more than two projections achieves repeated triggers of the contact member of the electrophotography imaging device by the contact, member.

Preferably, the cam is a cam groove formed on the end surface of the clutch gear, and the contact end is a slider installed inside the cam groove. The slider of the contact member slides in the cam groove and drives the contact, member to rotate.

Preferably, the contact member is installed on the exterior wall of the cartridge box by sliding, and the elastic member is a spring. The rotation of the rotation member drives the contact member to slide. When the contact member slides, the trigger end of the contact member triggers the contact member of the electrophotography imaging device.

Preferably, the cam has two or more projections along the circumference. The use of two or more projections achieves repeated triggers of the contact member of the electrophotography imaging device.

### EFFECTS OF THE INVENTION

According to the invention, the elastic friction layer of the rotation member is interference-fitted with the gear tooth top; the driving force of the gear is transmitted to the rotation member by friction and causes the rotation member to rotate; the cam of the rotation member causes the contact member to move; the contact end of the contact member triggers the contact member of the electrophotography imaging device; and information regarding whether the developer cartridge is new and. how much toner remains will be given to the electrophotography imaging device. When the rotation member rotates to a position where the small-diameter portion of the clutch gear is clearance fitted with the gear top, the rotation member is no longer in contact with the gear and the rotation stops. When a used developer cartridge is mounted to the electrophotography imaging device, the rotation member cannot rotate, the contact member cannot trigger the contact member of the electrophotography imaging device, and thus the developer cartridge is detected not to be new.

### BRIEF DESCRIPTION OF THE DRAWINGS

FIG. 1 is a three-dimensional view of Embodiment 1 of the invention.

FIG. 2 is a cross-sectional view of FIG. 1.

FIG. 3 is an expanded three-dimensional view of Embodiment 1 of the invention.

FIG. 4 is a three-dimensional view of the detection member of Embodiment 1.

FIG. 5 is a schematic view of the detection member of Embodiment 1 in the initial state.

FIG. 6 is a schematic view of the detection member of Embodiment 1 in the triggered state.

FIG. 7 is a schematic view of the detection member of Embodiment 1 after completion of the detection.

FIG. 8 is a schematic view of the detection section of Embodiment 2 in the initial state.

FIG. 9 is a schematic view of the detection member of Embodiment 2 in the first triggered state.

FIG. 10 is a schematic view of the detection member of Embodiment 2 after completion of the first triggering. FIG. 11 is a schematic view of the detection member of Embodiment 2 in the second triggered state.

FIG. 12 is a schematic view of the detection member of Embodiment 2 after completion of the detection.

FIG. 13 is a schematic view of the detection member of Embodiment 3 in the initial state.

FIG. 14 is a schematic view of the detection section of Embodiment 3 in the triggered state.

FIG. 15 is a schematic view of the detection member of Embodiment 4 in the initial state.

FIG. 16 is a schematic view of Embodiment 4 in the second triggered state.

FIG. 17 is a schematic view of the detection member of Embodiment 5 in the initial state.

FIG. 18 is a schematic view of the detection member of Embodiment 6 after completion of the detection.

FIG. 19 is a schematic view of the detection member of Embodiment 7 in the initial state.

FIG. 20 is a schematic view of the detection member of Embodiment 8 in the initial state.

### EMBODIMENTS OF THE INVENTION

The invention is illustrated by the combination of the embodiments and the drawings as follows.

### EMBODIMENT 1

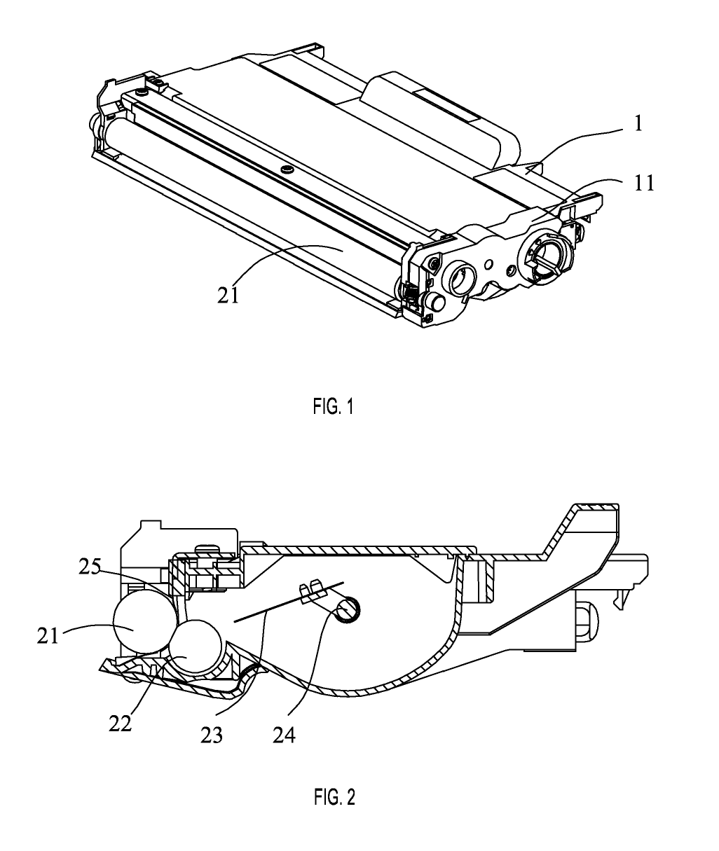

As shown in FIG. 1, the developer cartridge box 1 comprises a toner compartment for accommodating toner. The driving end of the cartridge box 1 is provided with an end cap 11. The toner compartment has a toner outlet. A developing roller 21 is rotationally installed on the toner outlet. The developer cartridge is detachably mounted, to the electrophotography imaging device . The toner compartment provides toner via developing roller 21 to the photosensitive drum to develop the electrostatic latent image.

FIG. 2 is a cross-sectional view of FIG. 1 perpendicular to the axial direction of the developing roller 21. FIG. 2 illustrates the internal structure of the developer cartridge, wherein the developing roller 21 is located on the toner outlet of the cartridge box 1. Inside the cartridge box 1 there are a toner feeding roller 22 which transfers the toner to the developing roller and a toner knife 25 which controls the toner thickness of the toner roller 21. A stirring member which comprises a stirring shaft 23 and a stirring blade 24 is placed inside the toner compartment. The developing roller 21, toner feeding roller 22 and the stirring member are rotationally supported on the end walls of the cartridge box.

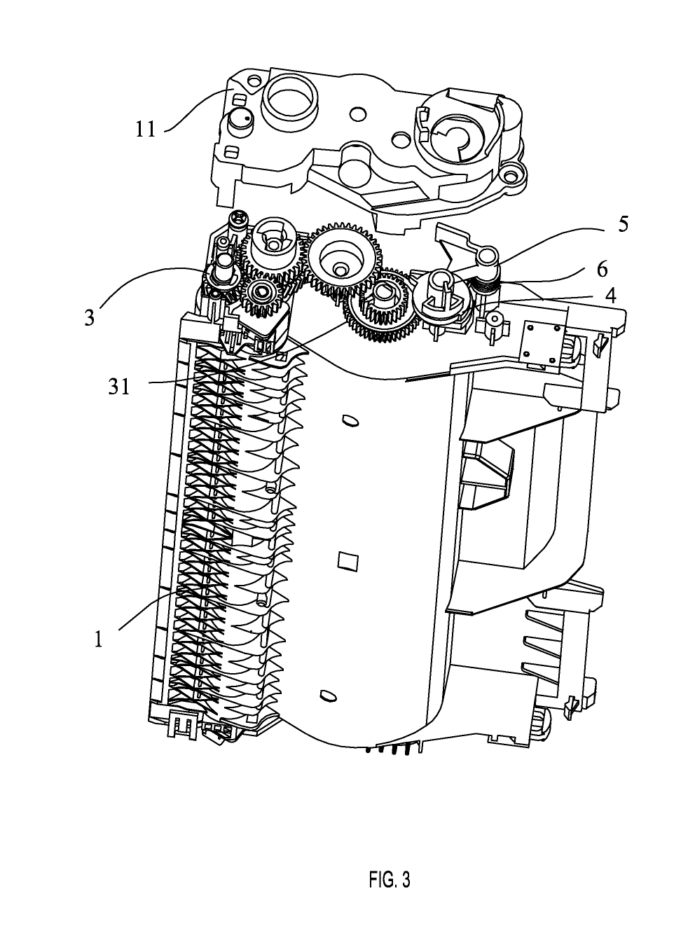

FIG. 3 illustrates the structure of the driving end of the developer cartridge. For clarity, the end cap 11 which is used to protect the internal structure is separated from the cartridge box 1. The driving roller 21, the toner feeding roller 22 and the gear set 3 of the stirring member are placed between the end wall of the cartridge box 1 and the end cap 11. The detection member comprises the rotation element 4 which is rotationally fixed to the exterior wall of the end wall and the contact member 5, wherein the rotation member 4 is adjacent to the gear 31 of the gear set 3. The contact member 5 urged by a torsion spring 6 applies a biasing force to the rotation member 4 and causes the contact member 5 to remain in contact with the rotation member 4, wherein the torsion spring 6 serve as the elastic member. It can be understood that the elastic member is not limited to a torsion spring and flat spring on the cartridge box can also force the contact member 5 to remain in contact, with the contact member 4. In this Embodiment, the gear 31 is the driving- gear for the stirring member. It can be understood that the rotation member 4 can be any gear of the adjacent gear set 3.

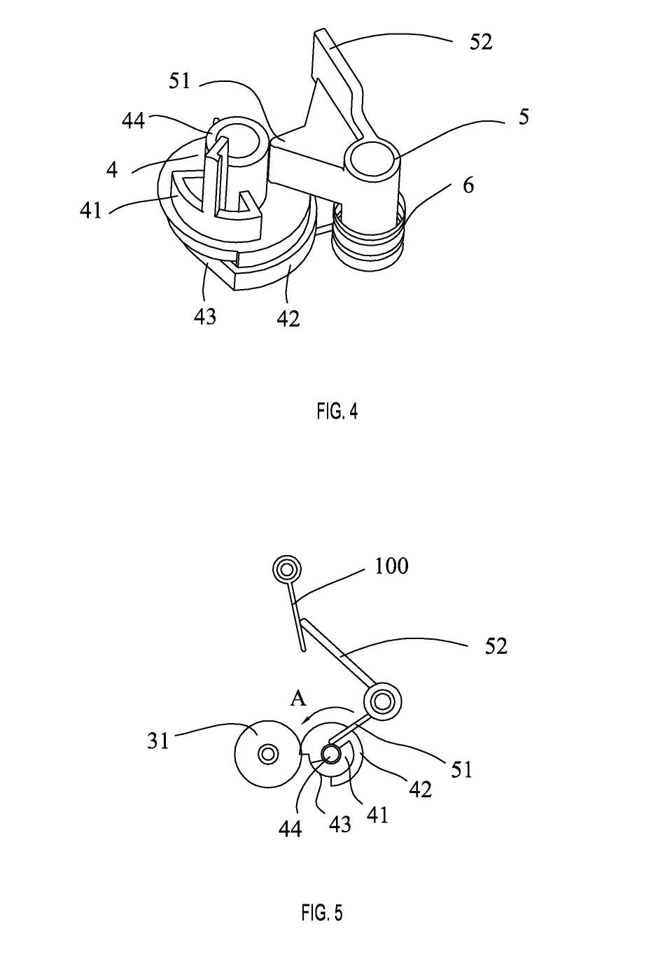

As shown in FIG. 4, the rotation member 4 is a clutch gear close to the cartridge box. The clutch gear has a large-diameter portion 42 and a small-diameter portion 43. The large-diameter portion 42 is provided with an elastic friction layer in the circumferential direction. The rotation member 4 is provided with a cam at the end away from the exterior wall. The cam is projecting axially and is coaxial with the clutch gear; it has a projection 41 and a coaxial center portion 44. The contact member 5 comprises a contact end 51 which may contact with the rotation member 4 and a trigger end 52 which extends in a direction perpendicular to the axial direction of the developing roller 21. The trigger end 52 is used to trigger the contact member 100 of the electrophotography imaging device. When the large-diameter portion 42 of the rotation member 4 faces the gear 31 (not shown), the elastic friction layer is interference-fitted with the gear top of the gear 31 and is driven by the gear 31 to rotate. When the small-diameter portion 43 faces the clutch gear 31, the small-diameter portion 43 is clearance fitted with the gear top of the gear 31 and the rotation member 4 cannot be driven by the gear 31 and thus cannot be rotated. The cam of the rotation member 4 and the clutch gear are in staggered phase, i.e., the projection of the cam 41 and the large-diameter portion 42 of the clutch gear are not in the same phase in a direction perpendicular to the axial direction.

FIGS. 5-7 are schematic views of the detection process of this Embodiment. When a new developer cartridge is mounted to the electrophotography imaging device, the gear set 3 receives the driving force and it rotates. FIG. 5 is a schematic view of the initial state. As shown in FIG. 5, the gear 31 rotates; the large-diameter portion 42 of the clutch gear of the rotation member 4 is interference-fitted with the gear top of the gear 31; the gear 31 drives the rotation member 4 by friction and thus the rotation member 4 rotates along the direction of arrow A; the contact end 51 of the contact member 5, under the elastic force of the torsion spring 6 (not shown), is in contact with the axial central portion 44 of the cam of the rotation member 4; and the trigger end 52 is in contact with the contact member 100 of the electrophotography imaging device.

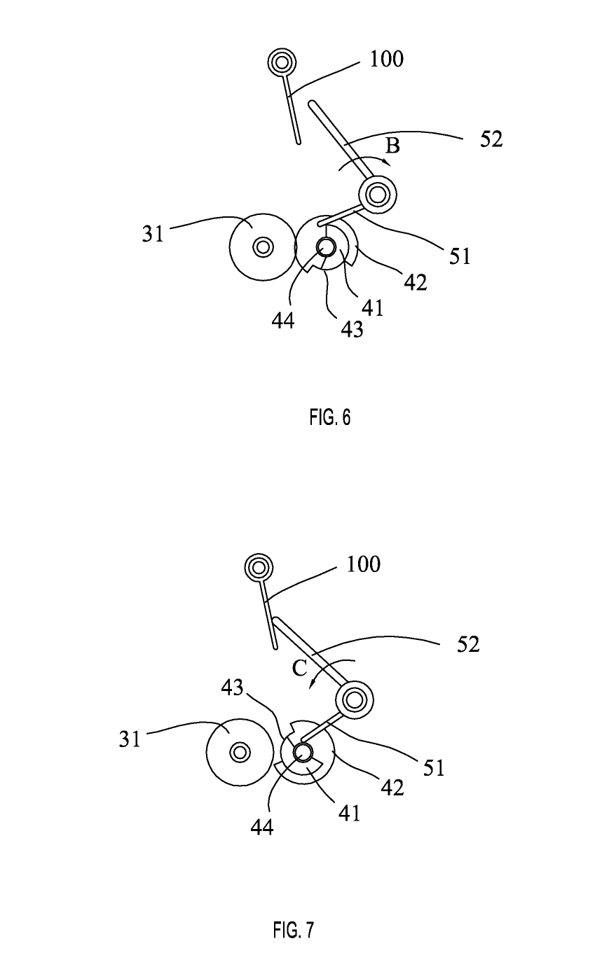

With further rotation of the rotation member 4, the projection 41 of the cam is in contact with the contact, end 51 and it pushes the contact member 5 against the torsion spring 6 and to rotate along the direction of arrow B, causing the trigger end 52 and the contact member 100 of the electrophotography imaging device to be disengaged to complete the triggering of the contact, member 100. As shown in FIG. 6, a message is transmitted to the electrophotography imaging device indicating whether the developer cartridge is new and how much toner is in the developer cartridge.

With further rotation of the rotation member 4, the projection 41 is gradually disengaged from the contact portion 51; the contact member 5, under the restoring force of the torsion spring 6 (not shown), rotates along the direction of arrow C. As shown in FIG. 7, when the small-diameter portion 43 of the rotation member 4 faces the gear 31, the gear top of the gear 31 is clearance-fitted with the rotation member 4, the rotation member 4 is no longer in contact with the gear 31, and the rotation of the rotation member 4 stops. The contact, end 51 of the contact member 5, under the restoring force of the torsion spring 6, remains in contact with the axial central portion 44 and stops rotating. The trigger end 52 remains in contact with the contact member 100 of the electrophotography imaging device.

When a used developer cartridge is mounted to the electrophotography imaging device, the rotation member 4 will not be in contact, with the gear 31 and thus will not rotate; the trigger end 52 of the contact member 5 will remain in contact with the contact member 100 of the electrophotography imaging device, indicating that the developer cartridge is not new.

### EMBODIMENT 2

The basic structure of the developer cartridge in this Embodiment is essentially the same as in Embodiment 1, except that, in this Embodiment, the cam of the rotation member 4 is provided with two projections 411 and 412.

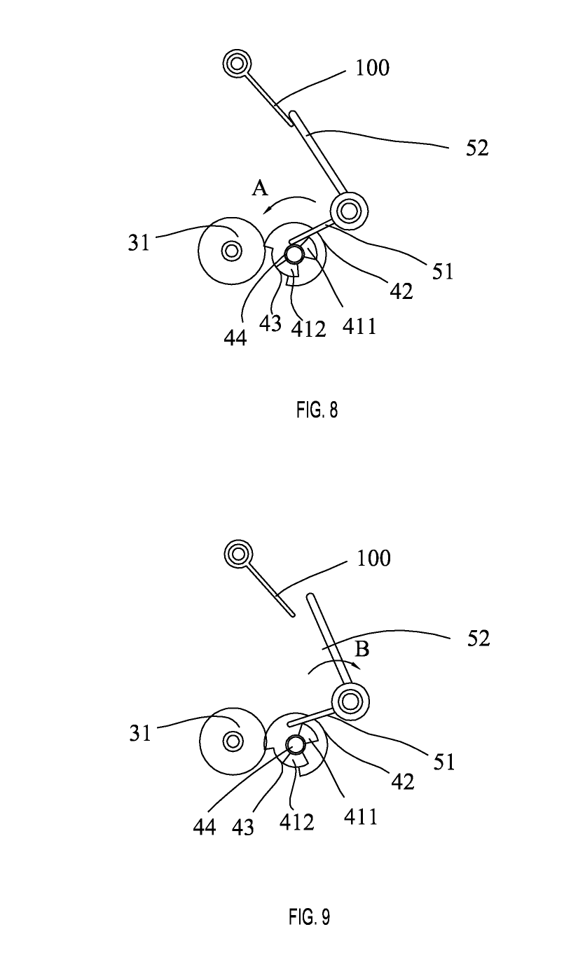

FIGS. 8-12 are schematic views of the detection process of this Embodiment. When the developer cartridge is mounted to the electrophotography imaging device, the large-diameter portion 42 of the rotation member 4 is interference-fitted with the gear top of the gear 31 and is driven by the gear 31 to rotate in the direction of arrow A. The contact end 51 of the contact member 5, under the elastic force of the torsion spring 6 (not shown), is in contact with the axial central portion 44 of the cam of the rotational member 4; and the trigger end 52 is contact with the contact member 100 of the printer, as shown in FIG. 8.

With further rotation of the rotation member 4, the projection 411 is in contact with the contact end 51 of the contact member 5; the contact member 5 is driven to rotate in the direction of arrow B; the trigger end 52 is disengaged from the contact member 100 of the electrophotography imaging device and completes the triggering of the contact member 100; a message is transmitted to the electrophotography imaging device indicating whether the developer cartridge is new and how much toner is in the cartridge, as shown in FIG. 9.

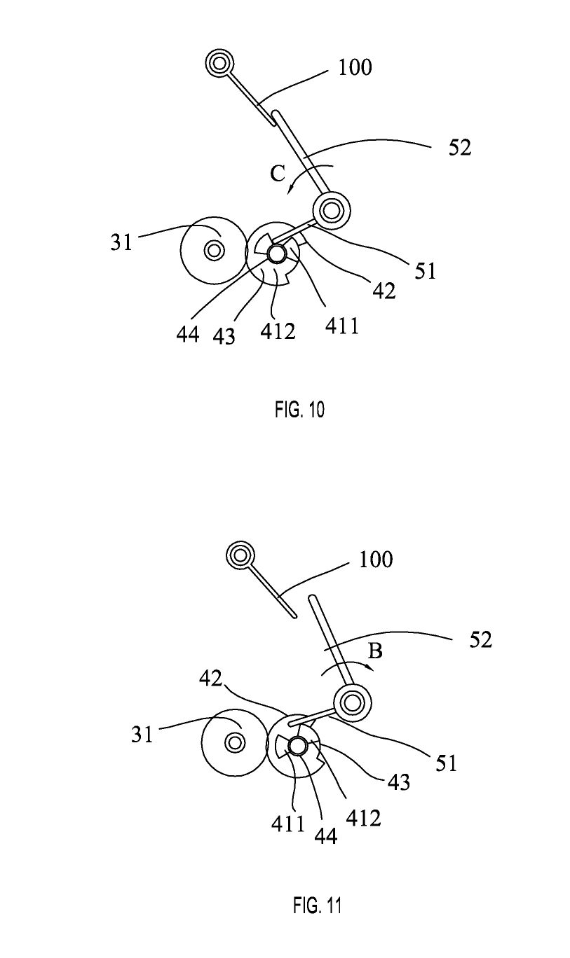

The rotation member 4 further rotates; the projection 411 is disengaged from the contact end 51; and the contact member 5, under the force of the torsion spring 6 (not shown), rotates in the direction of arrow C back to its initial position, as shown in FIG. 10.

With further rotation of the rotation member 4, the projection 412 is in contact with the contact end 51; the contact, member 5 is again pushed to rotate; the trigger end 52 again departs from the contact member 100 of the electrophotography imaging device and completes the second triggering of the contact member 100. A message is transmitted to the electrophotography imaging device indicating the remaining toner level in the developer cartridge, as shown in FIG. 11.

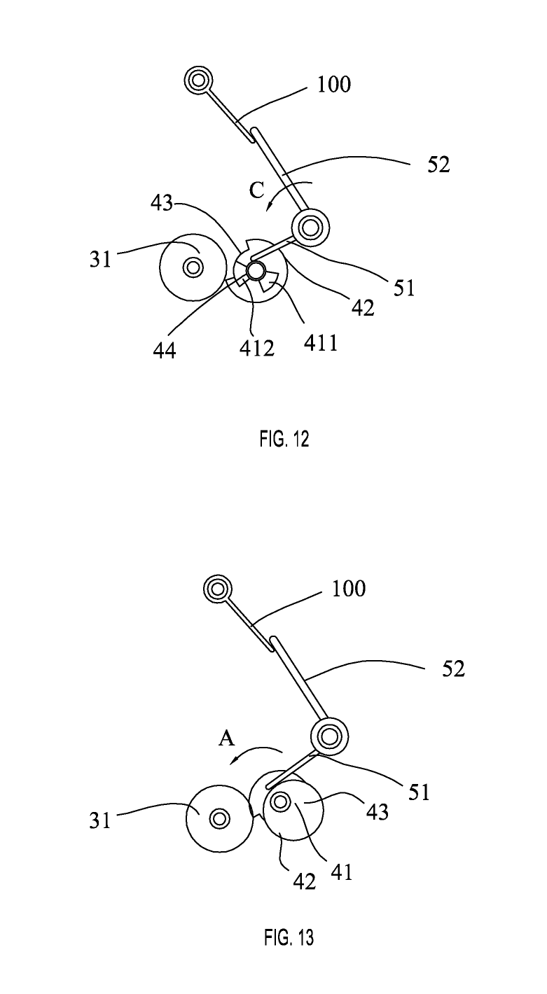

The rotation of the rotation member 4 continues until the small-diameter portion 43 of the clutch gear faces the gear 31 and the rotation member 4 no longer rotates with the gear 31; the contact member 5, under the elastic force of the torsion spring 6, returns to the initial position, as shown in FIG. 12.

In this Embodiment, more than two projections can be used to achieve multiple triggers of the contact member of the electrophotography imaging device.

### EMBODIMENT 3

The basic structure of the developer cartridge in this Embodiment is essentially the same as in Embodiment 1, except that, in this Embodiment, the cam 41 of the rotation member 4 is in smooth transition so that the movement of the contact member 5 is smoother.

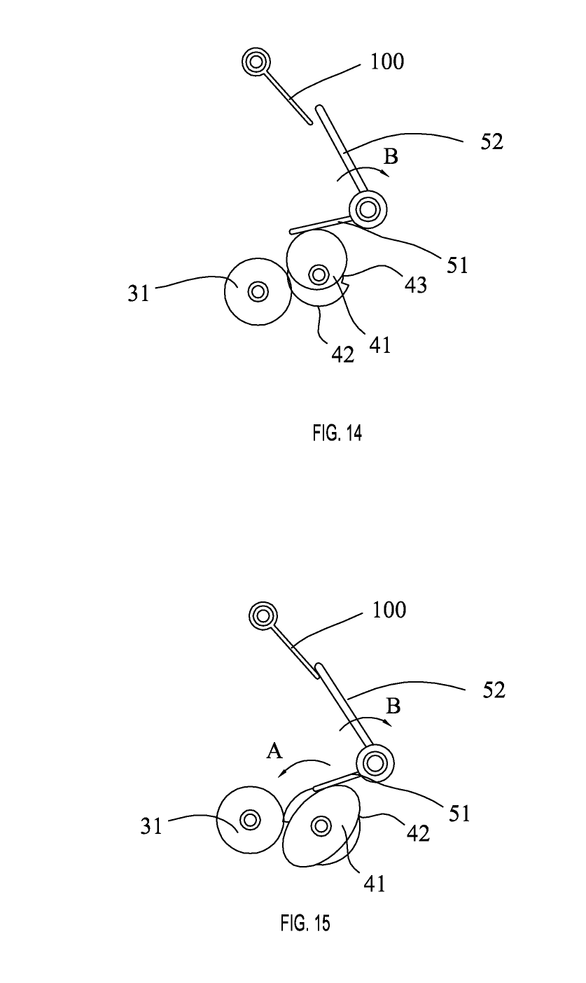

FIGS. 13 and 14 are schematic views of the detection process in this Embodiment. When the developer cartridge is mounted. to the electrophotography imaging device, the large-diameter portion 42 of the clutch gear of the rotation member 4 is interference-fitted with the gear top of the gear 31 and is driven to rotate by the gear 31 in the direction of arrow A; the contact end 51 of the contact member 5, under the force of the torsion spring 6, remains in contact with the exterior periphery of the cam 41; the trigger end 52 remains in contact with the contact member 100 of the electrophotography imaging device; and the contact member 5 is driven by the cam 41 to rotate in the direction of arrow B, as shown in FIG. 13.

When the rotation member 4 rotates to the high point of the cam 41 and is in contact, with the contact, end 51, the trigger end 52 of the contact member 5 disengages from the contact member 100 of the electrophotography imaging device and thus completes the triggering of the contact member 100, and a message is transmitted to the electrophotography imaging device indicating the developer cartridge being new and the toner level in the cartridge, as shown in FIG. 14.

With further rotation of the rotation member 4, the contact, member 5 gradually returns to the initial position. When the small-diameter portion 43 of the clutch gear of the rotation member 4 faces the gear 31, the rotation member 4 no longer rotates with the gear 31 and the contact member 5 stops rotating.

### EMBODIMENT 4

The basic structure of the developer cartridge in this Embodiment is essentially the same as in Embodiment 1, except that, in this Embodiment, the cam 41 of the rotation member 4 is provided with two smooth transition high, points, and therefore the electrophotography imaging device is smoothly triggered twice.

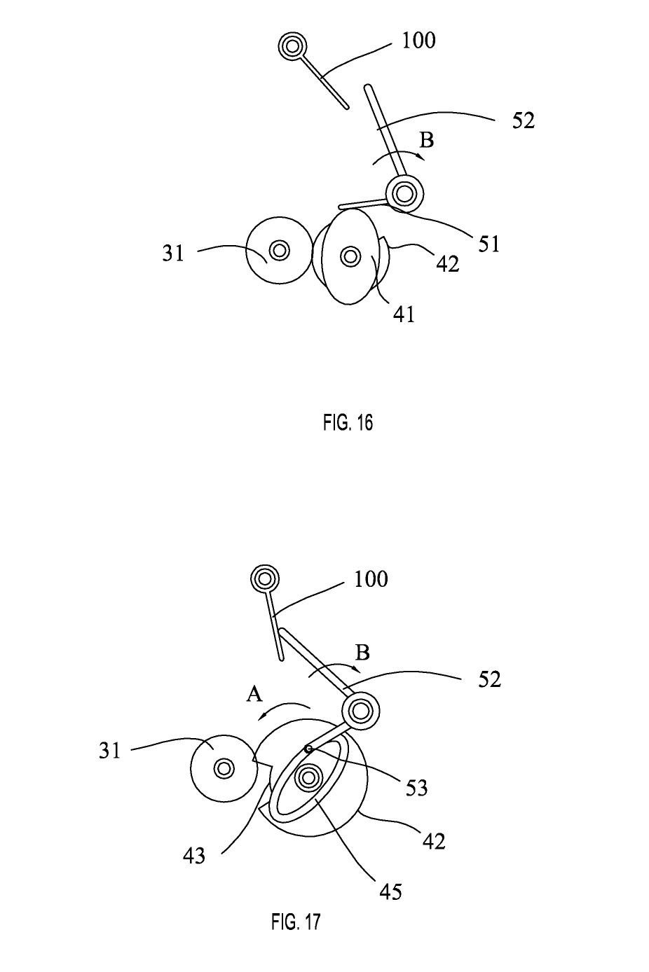

FIGS. 15 and 16 are schematic views of the detection process in this Embodiment. When the developer cartridge is mounted to the electrophotography imaging device, the large-diameter portion 42 of the clutch gear of the rotation member 4 is interference-fitted with the gear top of the gear 31 and is driven to rotate in the direction of arrow A. The contact end 51 of the contact member 5, under the elastic force of the torsion spring 6 (not shown), remains in contact with the exterior periphery of the cam 41; the trigger end 52 remains in contact with the contact member 100 of the electrophotography imaging device; and the contact member 5 is driven by the cam 41 to rotate in the direction of arrow B, as shown in FIG. 15.

When the high point of the cam 41 is in contact with the contact end 51, the trigger end 52 and the contact member 100 of the electrophotography imaging device are disengaged to complete the triggering of the contact, member 100. When the rotation member 4 rotates, the contact member 5 gradually returns to the initial position; the trigger end 52 again comes in contact with the contact member 100 of the electrophotography imaging device. With further rotation of the rotation member 4, the contact end 51 is in contact with another high point of the cam 41, and the trigger end 52 again departs from the contact member 100 and triggers the contact member 100, as shown in FIG. 16.

When the rotation member 4 rotates to a position where the small-diameter portion 43 of the clutch gear of the rotation member 4 faces the clutch gear 43, the rotation member 4 no longer rotates with the gear 31, and the contact member 5 no longer rotates.

### EMBODIMENT 5

The basic structure of the developer cartridge in this Embodiment is essentially the same as in Embodiment 1, except, that, in this Embodiment, the cam of the rotation member 4 is the cam. groove 45 formed by the clutch gear's side surface and the contact end. between the contact member 5 and the rotation member 4 is a slider 53 which is fitted with the cam groove 45 and slides therein.

FIG. 17 is a schematic view of the detection member in the initial state. After the developer cartridge is mounted to the electrophotography imaging device, the large-diameter portion 42 of the clutch gear of the rotation member 4 is interference-fitted with the gear top of the gear 31 and is driven to rotate in the direction of arrow A. The slider 53 of the contact member 5 slides in the cam groove 4 5 with the rotation of the rotation member 4 and drives the contact member 5 to rotate, and the trigger end 52 is in contact with the contact member 100 of the electrophotography imaging device, as shown in FIG. 17.

When the slider 53 moves to the high point of the cam groove 45, the trigger end 52 of the trigger member 5 is disengaged from the contact member 100 of the electrophotography imaging device and it completes the triggering of the trigger member.

With further rotation of the rotation member 4, the contact member 5 gradually returns to the initial position. When it rotates to a position where the small-diameter portion 43 of the clutch gear of the rotation member 4 faces the gear 31, the rotation member 4 no longer rotates with the gear 31, and the rotation of the contact member 5 stops.

### EMBODIMENT 6

The basic structure of the developer cartridge in this Embodiment is essentially the same as in Embodiment 1, except that, in this Embodiment, the rotation member 4 is provided with a small, pin-shaped projection 46 and the contact member 5 is provided with a groove 54 on the position where the contact member 5 is in contact with the rotation member. The groove 54 is used to accommodate the projection 46, The pin-shaped projection 45 can be considered as a cam rotating around the axis of the rotation member 4, and the groove 54 can be considered as a contact end which is in contact with the rotation member 4.

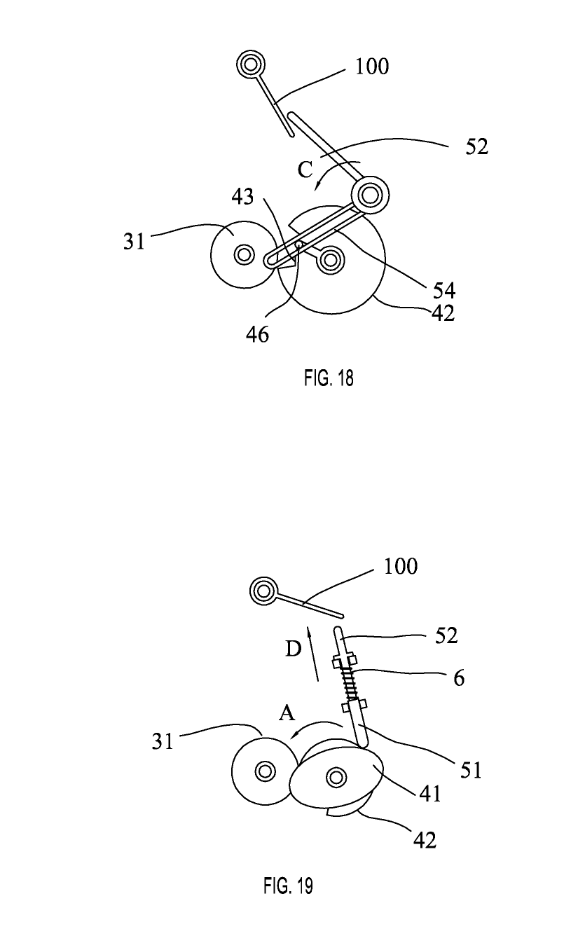

FIG. 18 is a schematic view of the detection member after the detection process is completed. Through the coordination between the projection 46 and the groove 54, the rotation member 4 drives the contact member 5 to rotate, and the trigger end 52 triggers the contact member 100 of the electrophotography imaging device.

In Embodiments 1-6, in the initial state, the trigger end 52 of the contact member 5 is in contact, with the contact member 100 of the electrophotography imaging device. After the rotation member 4 and the contact member 5 start to rotate, the trigger end 52 departs from the contact member 100 of the electrophotography imaging device and thus the contact member 100 is triggered. After the detection process is completed, the trigger end 52 of the contact member 5 remains in contact with the contact member 100 of the electrophotography imaging device.

### EMBODIMENT 7

The basic structure of the developer cartridge in this Embodiment is essentially the same as in Embodiment 1, except that, in this Embodiment, the cam 41 of the rotation member 4 is in smooth transition, the contact member 5 is fixed on the exterior wall of the developer cartridge by sliding, and the elastic member which applies the spring force to the contact member 5 is the compression spring 6.

FIG. 19 is a schematic view of the detection member in the initial state. When the developer cartridge is mounted to the electrophotography imaging device, the large-diameter portion 42 of the clutch gear of the rotation member 4 is interference-fitted with the gear top of the gear 31 and is driven by the gear 31 to rotate in the direction of arrow A. The contact, end 51 of the cam. 41 which is in contact with the contact member 5 is pushed by the cam and causes the trigger end 52 of the contact member 5 to overcome the elastic force of the tension spring 6 and to rotate in the direction of arrow D. When the contact, end 51 moves to the high point of the cam 41, the trigger end 52 of the contact member 5 triggers the contact, member 100 of the electrophotography imaging device. With further rotation of the rotation member 4, the contact member 5, under the restoring force of the compression spring 6, gradually returns to the initial position; when the small-diameter portion 43 of the clutch gear of the rotation member 4 faces the gear 31, the rotation member 4 no longer rotates with the gear 31, and the contact, member 5 no longer moves.

### EMBODIMENT 3

The basic structure of the developer cartridge in this Embodiment is essentially the same as in Embodiment 7, except that, there are some differences in the structures of the cam 41 of the rotation member 4 and the contact member 5. In this Embodiment, the elastic member which compresses the contact member 5 is the tension spring 6.

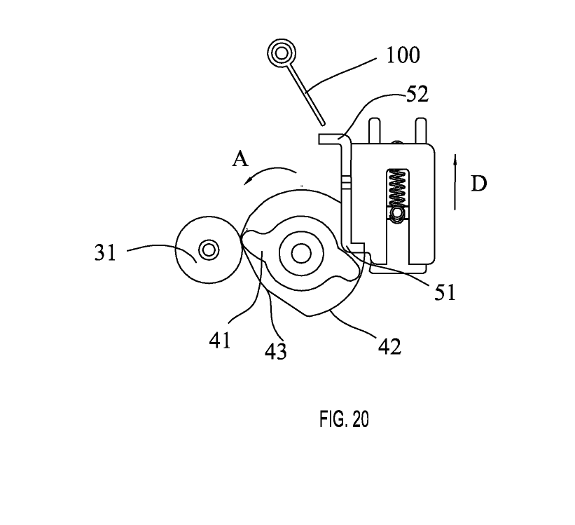

FIG. 20 is a schematic view of the detection member in the initial state. When the developer cartridge is mounted, to the electrophotography imaging device, the large-diameter portion 42 of the clutch gear of the rotation member 4 is interference-fitted with the gear top of the gear 31 and is driven by the gear 31 to rotate in the direction of arrow A; the contact end 51 of the cam 41 which is in contact with the contact member 5 is pushed by the cam and causes the trigger end 52 of the contact, member 5 to overcome the elastic force of the tension spring 6 and to rotate in the direction of arrow D. When the contact end 51 moves to the high point of the cam 41, the contact end 52 of the contact member 5 triggers the contact member 100 of the electrophotography imaging device. With further rotation of the rotation member 4, the contact member 5 under the restoring force of the tension spring 6 gradually returns to the initial position; when the small-diameter portion 43 of the clutch gear of the rotation member 4 faces the gear 31, the rotation member 4 no longer rotates with the gear 31 and the contact member 5 no longer moves.

In Embodiments 7 and 8, in the initial state, the trigger end 52 of the contact member 5 is not. in contact with the contact member 100 of the electrophotography imaging device. When the rotation member 4 rotates, the contact, member 5 is pushed, by the rotation member 4 to slide, the trigger end 52 is in contact with the contact member 100 of the electrophotography imaging device, and the contact member 100 is triggered. After the detection is completed, the trigger end 52 of the contact member 5 is no longer in contact with the contact member 100 of the electrophotography imaging device.

It can be understood that in Embodiments 1-6, the detection member of the developer cartridge can also be applied to the electrophotography imaging device in Embodiments 7 and 8, i.e., the contact member 5 of the detection member can be set not. to be in contact, with the contact member 100 of the electrophotography imaging device in the initial state. During the detection, the contact member 5 is in contact with the contact member 100 and completes the triggering of the contact member 100. After the detection is completed, the contact, member 5 is no longer in contact with the contact member 100 , Embodiments 7 and 8 can also be applied to the electrophotography imaging device in Embodiments 1-6, i.e., the contact member 5 of the detection member can be set to be in contact with the contact member 100 of the electrophotography imaging device in the initial state, and during the detection, it departs from the contact member 100 to complete the triggering of the contact member 100. After the detection is completed, the contact member 5 remains in contact with the contact member 100.

It can be understood that the invention is not limited to the above embodiments. Many variations will still, fall within the scope of the invention.

### INDUSTRIAL APPLICABILITY

The rotation member of the invention eliminates the tooth portion, and thus its structure is simple and. less costly to make. The developer cartridge having this rotation member is less costly to make. Compared with a gear, the movement driven by the elastic friction layer is easy to control and does not create noise and vibration problems. The trigger end of the contact member can be set freely in the direction perpendicular to the axial direction of the developing roller, and, therefore, the detection position can be more conveniently set.

What is claimed is:

1. A developer cartridge, comprising
a cartridge box comprising a toner compartment and a toner outlet; a stirring member being rotationally supported inside the toner compartment;
a developing roller being rotationally supported on the toner outlet;
a gear set being installed on the exterior wall of the cartridge box which receives driving force and drives the stirring member and the developing roller;
a rotation member being rotationally installed on the exterior wall of the cartridge box and being provided with a clutch gear and a coaxial cam; wherein the clutch gear comprises a small-diameter portion which is clearance-fitted with one gear top of the gear set and a large-diameter portion which is interference-fitted with the gear top; the large-diameter portion being provided with an elastic friction layer around the circumference, and the cam being in a staggered phase with the clutch gear;
a contact member being rotationally installed on the exterior wall of the cartridge box and being provided with a contact end for contacting with the cam and a triggering end; and
an elastic member being installed between the cartridge box and the contact member for forcing the contact end to be in contact, with the cam.

2. The developer cartridge of claim 1, wherein the contact member is rotationally installed on the exterior wall of the cartridge box, and wherein the elastic member is a torsion spring.

3. The developer cartridge of claim 2, wherein the cam is provided with two or more projections along the circumference.

4. The developer cartridge of claim 2, wherein the cam is a cam groove formed on the end surface of the clutch gear, and wherein the contact end is a slider installed inside the cam groove.

5. The developer cartridge of claim 1, wherein the contact member is installed on the exterior wall of the cartridge box by sliding and the elastic member is a spring.

6. The developer cartridge of claim 5, wherein the cam comprises more than two projections along the circumference.
